(19) United States
(12) Patent Application Publication
(10) Pub. No.: US 2026/0343373 A1
(43) Pub. Date: Oct. 29, 2026

(54) ELECTRONIC APPARATUS, METHOD FOR CONTROLLING ELECTRONIC APPARATUS, AND STORAGE MEDIUM

(71) Applicant: CANON KABUSHIKI KAISHA, Tokyo (JP)

(72) Inventors: KENICHIRO SUGA, Saitama (JP); YUICHI YAGI, Tokyo (JP)

(21) Appl. No.: 19/736,727

(22) Filed: Jul. 9, 2026

Related U.S. Application Data
(62) Division of application No. 18/757,215, filed on Jun. 27, 2024.

(30) Foreign Application Priority Data
Jun. 30, 2023 (JP) 2023-107821
Jun. 30, 2023 (JP) 2023-107822

(51) Int. Cl. H04W 36/38; H04W 36/30; H04L 5/00

(52) U.S. Cl. CPC H04W 36/38; H04W 36/305; H04L 5/0007

(57) ABSTRACT

An electronic apparatus includes a receiving unit configured to receive a change request from a currently connected access point (AP) to change a connection destination AP to connect to; a processing unit configured to communicate with another apparatus via the currently connected AP and perform a specific process including transmission or reception of data; and a control unit configured to, in case where a connection destination change based on the change request is performed in a first state in which part of data for the specific process has been received or transmitted through communication with the other apparatus and reception or transmission of rest of the data has not been completed, perform control to interrupt the specific process and cancel a standby mode waiting for the reception or transmission of the rest of the data.

### CROSS REFERENCE TO RELATED APPLICATION

This application is a Divisional of U.S. Patent Application No. 18/757,215, filed on Jun. 27, 2024, which claims the benefit of Japanese Patent Application No. 2023-107822 filed Jun. 30, 2023, and Japanese Patent Application No. 2023-107821, filed Jun. 30, 2023, which are hereby incorporated by reference herein in its entirety.

### BACKGROUND

### FIELD

The present disclosure relates to an electronic apparatus capable of changing a connection destination access point (AP) to connect to in accordance with a connection destination change request from the AP, a method for controlling the electronic apparatus, and a storage medium.

### DESCRIPTION OF THE RELATED ART

A technique for an extended service set (ESS) including a plurality of APs involves dynamically switching a connection destination AP to which a station (STA) is to connect in the ESS to efficiently exchange data between the AP and the STA. When it is determined that the AP as the connection destination is to be switched on the basis of, for example, the congestion of the AP to which the STA is currently connected, the occupancy of the other APs, or radio wave conditions, the currently connected AP transmits an AP change request to the STA. Upon receiving the AP change request, the STA switches the connection destination AP in accordance with the request to connect to an appropriate AP.

Japanese Patent Laid-Open No. 2021-175068 discloses the following process for transmitting a request from a router having an AP function to a currently connected wireless slave unit to change a connection destination. A mobile router (MR1) connectable to a plurality of wireless slave units checks whether a wireless slave terminal supports Institute of Electrical and Electronics Engineers (IEEE) 802.11v. Whether the wireless slave terminal supports IEEE 802.11v can be determined from an Association Request frame transmitted from the wireless slave terminal to wirelessly connect to the MR1. If the wireless slave terminal supports IEEE 802.11v, a basic service set (BSS) transition management (BTM) Request frame is transmitted to the wireless slave terminal. In the BTM Request frame, a BSS Transition Candidate List Entries field specifies a basic service set identifier (BSSID) of a master router RT2 as the connection destination. Accordingly, switching of the connection destination of the slave terminal is prompted. In accordance with the received BTM Request frame, the wireless slave terminal switches the connection destination from the MR1 to the master router RT2.

### SUMMARY

Various embodiments of the present disclosure provide a mechanism for improving convenience for a change of an AP serving as a connection destination according to a request for changing the connection destination during a specific process involving communication.

An electronic apparatus according to one embodiment of the present disclosure includes at least one memory and at least one processor which function as a receiving unit configured to receive a change request from a currently connected access point (AP) to change a connection destination AP to connect to; a processing unit configured to communicate with another apparatus via the currently connected AP and perform a specific process including transmission or reception of data; and a control unit configured to, in case where a connection destination change based on the change request is performed in a first state in which part of data for the specific process has been received or transmitted through communication with the other apparatus and reception or transmission of rest of the data has not been completed, perform control to interrupt the specific process and cancel a standby mode waiting for the reception or transmission of the rest of the data.

Further features of the present disclosure will become apparent from the following description of exemplary embodiments with reference to the attached drawings.

### BRIEF DESCRIPTION OF THE DRAWINGS

FIG. 1 is a diagram illustrating an example configuration of a system.

FIGS. 2A and 2B are diagrams illustrating an example configuration of a multifunction peripheral (MFP).

FIGS. 3A, 3B, and 3C are illustrations of example screens displayed on an operation display unit of the MFP.

FIGS. 4A and 4B are diagrams illustrating a configuration of a mobile terminal device.

FIG. 5 is a configuration diagram of an access point (AP).

FIG. 6 is a sequence diagram illustrating a process performed in response to a connection destination change request from the AP.

FIG. 7 is a flowchart of a process performed by the MFP in response to a connection destination change request from the AP.

FIG. 8 is a flowchart of a connection destination change process performed by the MFP.

### DESCRIPTION OF THE EMBODIMENTS

Example embodiments of the present disclosure will be described in detail hereinafter with reference to the drawings. It should be noted that the described embodiments are merely examples and specific examples of components, processing steps, display screens, and so on are not intended to limit the scope of the invention unless otherwise specified.

STAs have a state in which switching of a connection destination AP causes no issue, and a state in which switching of the connection destination AP or disconnection from a currently connected AP causes an issue. That is, an STA may have an issue if a request for changing a connection destination AP is received from a currently connected AP and the connection destination AP is switched in response to the request. The STA may also have an issue when disconnected from the currently connected AP if the STA does not respond to the request for changing the connection destination AP received from the currently connected AP.

An issue may occur, for example, when the STA is printing print data received from another device such as a smartphone or a personal computer (PC) via the currently connected AP. In this case, if a request for changing the connection destination AP is received and the connection destination AP is switched in response to the request, the Internet Protocol (IP) address of the STA may change. Then, the STA whose IP address has changed is not recognizable to the other device, which prevents the other device from transmitting the subsequent part of the print data being printed. Accordingly, the unreceived part of the print data being printed is not receivable by the STA, and the STA fails to complete printing. In this case, the STA is in reception standby mode in which the STA waits for reception of the rest (i.e., the unreceived part) of the print data during printing. However, the rest is not transmitted, the reception standby mode continues. During the period of time in which the reception standby mode continues, no other processes can be performed, making it difficult to quickly perform another subsequent process while printing is in progress. Also in a case where the connection destination AP is switched during transmission or reception of data other than the print data, the rest of the data may be prevented from being transmitted or received to complete processing.

To address the issue described above, various embodiments of the present disclosure provide a mechanism for preventing failure to perform another process immediately upon a change of an AP serving as a connection destination according to a request for changing the connection destination during a specific process involving communication.

In addition, when printing print data received from another device such as a smartphone or a PC via the currently connected AP, the STA receives a request for changing the connection destination AP and switches the connection destination AP in accordance with the request, which may result in a change of the IP address of the STA. Then, the unreceived part of the print data being printed is not receivable by the STA, and the STA fails to complete printing. Also, in a case where the connection destination AP is switched during transmission or reception of data other than the print data, the rest of the data may be prevented from being transmitted or received to complete processing.

To address the issue described above, various embodiments of the present disclosure provide a mechanism that can prevent failure in transmission or reception of data when an AP serving as a connection destination is switched in response to a request for changing the connection destination.

### System Configuration

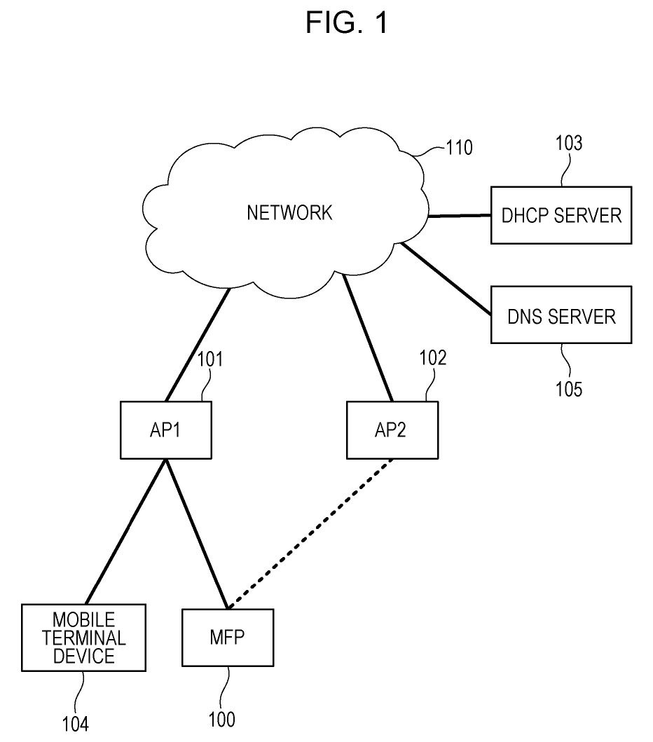

FIG. 1 illustrates an example configuration of a system according to the present embodiment. In one example, the system is a wireless communication system in which a plurality of communication devices can wirelessly communicate with each other. In the example illustrated in FIG. 1, the communication devices include a mobile terminal device 104, an MFP 100, access points AP1 (101) and AP2 (102), a dynamic host configuration protocol (DHCP) server 103, a domain name system (DNS) server 105, and a network 110. The mobile terminal device 104 is a device having a wireless communication function using a wireless local area network (LAN) or the like. The wireless LAN may be hereinafter referred to as a WLAN. The mobile terminal device 104 may be, for example, a personal information terminal such as a personal digital assistant (PDA), a mobile phone (smartphone), a digital camera, or a personal computer (PC).

The MFP 100 is a printer having a printing function. The MFP 100 may also have a reading function (scanner), a facsimile transmission (fax) function, and a telephone function. In the present embodiment, the MFP 100 also has a communication function for wirelessly communicating with the mobile terminal device 104. The present embodiment describes the MFP 100, by way of example but not limitation. Instead of the MFP 100, any other device having a communication function, such as a scanner device, a projector, a mobile terminal, a smartphone, a laptop PC, a tablet terminal, a PDA, a digital camera, a music playing device, a television, or a smart speaker, may be used. MFP is an acronym for Multi Function Peripheral.

The access point AP1 (101) is disposed separately from (or outside) the mobile terminal device 104 and the MFP 100, and operates as a WLAN base station device. A communication device having a WLAN communication function can perform communication in infrastructure mode for WLANs via the access point AP1 (101). In the following description, the access points may be referred to as "APs". The infrastructure mode for WLANs may be referred to as "wireless infrastructure mode". The access point AP1 (101) performs wireless communication with a communication device (authenticated communication device) allowed to connect to the access point AP1 (101), and relays wireless communication between the communication device and another communication device. The access point AP1 (101) may be connected to, for example, a wired communication network and may relay communication between a communication device connected to the wired communication network and another communication device wirelessly connected to the access point AP1 (101).

The access point AP2 (102) has a function equivalent to that of the access point AP1 (101). The MFP 100 switches the connection from the access point AP1 (101) to the access point AP2 (102), if necessary. The DHCP server 103 is connected to the MFP 100 via the access point AP1 (101) and the network 110, and responds to a request from the MFP 100 to provide a service to the MFP 100. In FIG. 1, the DHCP server 103 is connected as a device different from the access points AP1 (101) and AP2 (102). However, the access points AP1 (101) and AP2 (102) may have a DHCP server function. The DNS server 105 is connected to the MFP 100 and the mobile terminal device 104 via the access point AP1 (101) and the network 110, and responds to a request from the MFP 100 or the mobile terminal device 104 to provide a service for name resolution. The network 110 may be the Internet, a closed network within a company, or a mobile telephone network.

### Appearance of MFP

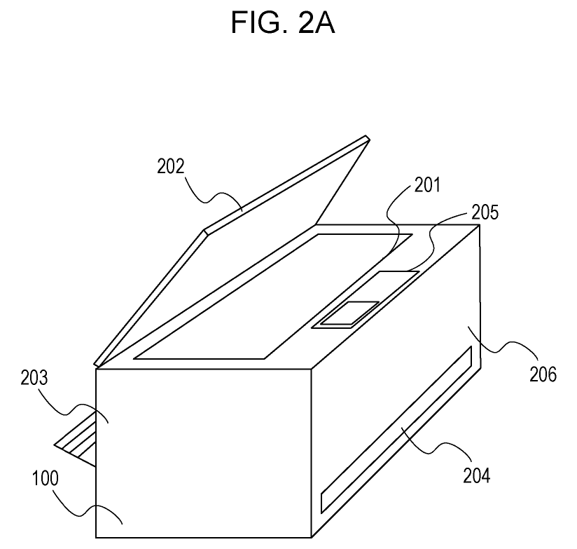

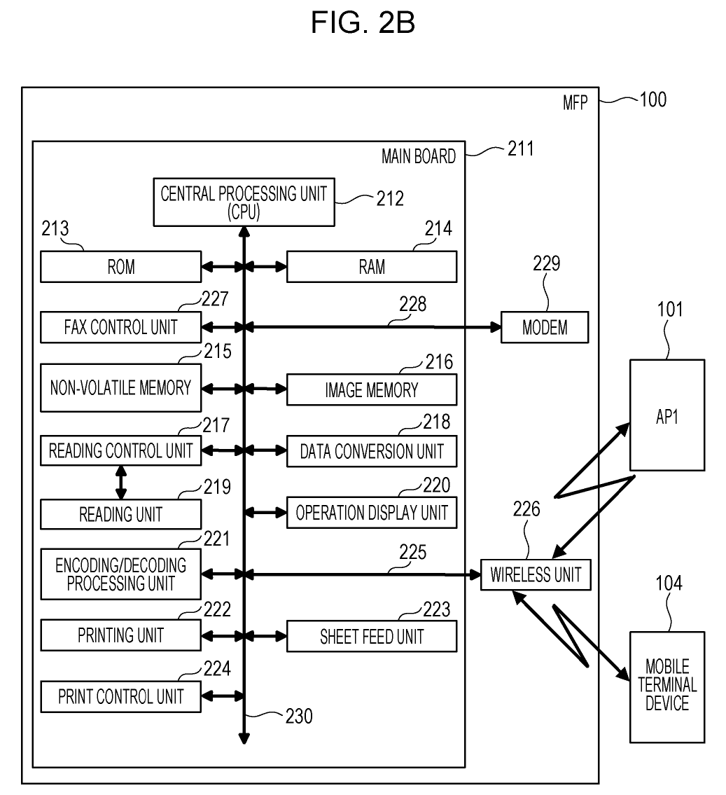

FIG. 2A illustrates an example appearance of the MFP 100. The MFP 100 includes, for example, a document table 201, a document cover 202, a print sheet insertion port 203, a print sheet discharge port 204, and an operation display unit 205. The document table 201 is a table on which a document to be read is placed. The document cover 202 is a cover to be closed to press a document placed on the document table 201 and prevent external leakage of light from a light source with which the document is irradiated during reading of the document. The print sheet insertion port 203 is an insertion port in which sheets of various sizes can be set. The print sheet discharge port 204 is a discharge port through which a printed sheet is discharged. The sheets set in the print sheet insertion port 203 are conveyed one by one to a printing unit 222 (described below), printed by the printing unit 222, and then discharged through the print sheet discharge port 204. The operation display unit 205 includes keys such as a character input key, a cursor key, an enter key, and a cancel key, a light-emitting diode (LED), a liquid crystal display (LCD), and so on. The operation display unit 205 is configured to accept operations performed by a user, such as the activation of various MFP functions and the setting of various settings. The operation display unit 205 may further include a touch panel display. The MFP 100 has a wireless communication function using a WLAN, and includes a wireless communication antenna 206 for wireless communication. The wireless communication antenna 206 may be invisible from the outside. Like the mobile terminal device 104, the MFP 100 can also perform wireless communication using a WLAN in a frequency band such as the 2.4 GHz or 5 GHz band.

### Configuration of MFP

FIG. 2B illustrates an example configuration of the MFP 100. The MFP 100 includes a main board 211 for performing main control of the MFP 100, and a wireless unit 226. The wireless unit 226 is one communication module for performing WLAN communication by using at least one common antenna. The MFP 100 further includes a modem 229 for performing wired communication, for example. The main board 211 includes, for example, a central processing unit (CPU) 212, a read-only memory (ROM) 213, a random access memory (RAM) 214, a non-volatile memory 215, an image memory 216, a reading control unit 217, a data conversion unit 218, a reading unit 219, and an encoding/decoding processing unit 221. The main board 211 further includes, for example, the printing unit 222, a sheet feed unit 223, a print control unit 224, an operation display unit 220, and a fax control unit 227.

The functional units in the main board 211 described above are connected to each other via a system bus 230 managed by the CPU 212. The main board 211 and the wireless unit 226 are connected via, for example, a dedicated bus 225. The main board 211 and the modem 229 are connected via, for example, a bus 228.

The CPU 212 is a system control unit including at least one processor, and controls the overall operation of the MFP 100. In one example, the processes of the MFP 100, which will be described below, are implemented by the CPU 212 executing a program stored in the ROM 213. Hardware dedicated for each of the processes may be provided. The ROM 213 stores a control program executed by the CPU 212, an embedded operating system (OS) program, and so on. In the present embodiment, the CPU 212 executes each control program stored in the ROM 213 under the management of the embedded OS stored in the ROM 213 to control software such as for scheduling and for switching tasks.

The RAM 214 includes a static random access memory (SRAM), for example. The RAM 214 stores data such as data of program control variables, setting values registered by the user, and data for managing the MFP 100. The RAM 214 may also be used as a buffer for various works. The non-volatile memory 215 includes a memory such as a flash memory, for example, and stores data continuously even after the power to the MFP 100 is turned off. The image memory 216 includes a memory such as a dynamic random access memory (DRAM). The image memory 216 stores image data received via the wireless unit 226, image data processed by the encoding/decoding processing unit 221, and so on. The memory configuration of the MFP 100 is not limited to the configuration described above. The data conversion unit 218 performs processing such as analysis of data in various formats and conversion from image data to print data.

The reading control unit 217 controls the reading unit 219 (e.g., a contact image sensor (CIS)) to optically read a document placed on the document table 201. The reading control unit 217 converts an image obtained by optically reading the document into electrical image data (image signal) and outputs the electrical image data. At this time, the reading control unit 217 may perform various kinds of image processing such as binarization and halftoning before outputting the image data.

The operation display unit 220 corresponds to the operation display unit 205 described with reference to FIG. 2A, and executes processing such as displaying on the display under display control by the CPU 212 and generating a signal in response to acceptance of a user operation.

The encoding/decoding processing unit 221 performs encoding processing, decoding processing, and enlargement/reduction processing of image data (such as Joint Photographic Experts Group (JPEG) data or Portable Network Graphics (PNG) data) handled by the MFP 100.

The sheet feed unit 223 holds sheets for printing. The sheet feed unit 223 can feed a set sheet under the control of the print control unit 224. The sheet feed unit 223 may include a plurality of sheet feed units to hold a plurality of types of sheets in a single device, and control can be performed to determine from which of the sheet feed units to feed a sheet under the control of the print control unit 224.

The print control unit 224 performs various kinds of image processing such as smoothing processing, print density correction processing, and color correction on image data to be printed, and outputs the processed image data to the printing unit 222. The printing unit 222 is configured to execute, for example, an inkjet printing process. The printing unit 222 ejects ink supplied from an ink tank through a print head and records an image on a recording medium such as a sheet of paper. The printing unit 222 may be configured to execute another printing process such as an electrophotographic printing process. Further, the print control unit 224 may periodically read information on the printing unit 222 and update, for example, status information stored in the RAM 214. The status information includes, for example, the remaining amount of the ink tank, and the state of the print head.

The wireless unit 226 is a unit capable of providing a WLAN communication function. For example, the wireless unit 226 can provide a function similar to that of a combination with a WLAN unit 401 of the mobile terminal device 104. That is, in accordance with the WLAN standard, the wireless unit 226 converts data into packets and transmits the packets to another device, or restores packets from another external device into original data and outputs the original data to the CPU 212. The wireless unit 226 can perform communication as a station conforming to the series of IEEE 802.11 standards. In particular, the wireless unit 226 can perform communication as an IEEE 802.11a/b/g/n/ac/ax station. In the following description, a station may be referred to as an STA. In addition, the wireless unit 226 can perform communication as a Wi-Fi Agile Multiband (trademark) STA.

The wireless unit 226 supports IEEE 802.11ax, or Wi-Fi 6 (trademark), and can perform processes compliant with IEEE 802.11ax. That is, the MFP 100 can perform one or both of processing of an STA supporting (or compatible with) OFDMA and an operation (processing) of an STA supporting (or compatible with) TWT. OFDMA is short for Orthogonal Frequency Division Multiple Access. TWT is short for Target Wake Time. Since the wireless unit 226 supports TWT, the timing of data communication from the master device to the STA is adjusted. The wireless unit 226 (i.e., the MFP 100) serving as an STA puts the communication function into sleep state when there is no need to wait for signal reception. This configuration can reduce power consumption. The wireless unit 226 also supports Wi-Fi 6E (trademark). That is, the wireless unit 226 can also perform communication over the 6 GHz band (5.925 GHz to 7.125 GHz). The 6 GHz band does not include a target band in which dynamic frequency selection (DFS) is implemented, which is included in the 5 GHz band. In the communication over the 6 GHz band, accordingly, communication disconnection caused by the DFS waiting time does not occur. As a result, it can be expected to perform more comfortable communication.

The mobile terminal device 104 and the MFP 100 can perform peer-to-peer (P2P) (WLAN) communication based on Wi-Fi Direct (WFD), and the wireless unit 226 has a software access point (Soft-AP) function or a group owner function. That is, the wireless unit 226 can establish a P2P communication network and determine a channel to be used for P2P communication.

### Operation Display Unit of MFP

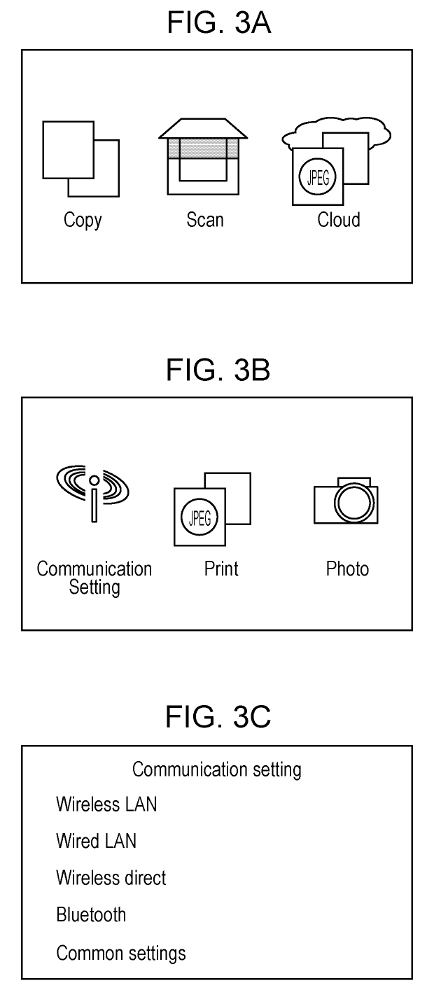

FIGS. 3A to 3C schematically illustrate example screens displayed on the display (touch panel display) included in the operation display unit 220 of the MFP 100. FIG. 3A illustrates an example of a home screen displayed when operation such as printing or scanning does not take place after power to the MFP 100 is turned on (when the MFP 100 is in idle state or standby state). In FIG. 3A, display items (menu items) marked "Copy", "Scan", and "Cloud" are displayed. The item "cloud" is a menu item related to a cloud function using Internet communication. When one of the menu items is selected by a key operation or a touch panel operation, the MFP 100 can start implementing a corresponding setting or function. The MFP 100 accepts a key operation or a touch panel operation on the home screen illustrated in FIG. 3A to seamlessly display a screen different from that illustrated in FIG. 3A.

FIG. 3B illustrates a display example of another portion of the home screen. In response to an operation of displaying another page of the home screen (such as sliding from left to right or vice versa), a transition occurs from the state illustrated in FIG. 3A to a screen illustrated in FIG. 3B. In FIG. 3B, display items (menu items) marked "Communication setting", "Print", and "Photo" are displayed. When one of these menu items is selected, a function corresponding to the selected menu item, that is, one of a print function, a photo function, and communication setting, is implemented.

FIG. 3C illustrates a display example of a menu screen for communication setting, which is displayed when the communication setting is selected on the screen illustrated in FIG. 3B. The menu screen for communication setting displays menu items (options) "Wireless LAN", "Wired LAN", "Wireless direct", "Bluetooth", and "Common settings". The items "Wireless LAN", "Wired LAN", and "Wireless direct" are menu items for performing LAN setting, and one of these items is used to perform setting such as setting a wired connection, enabling or disabling the wireless infrastructure mode, or enabling or disabling the P2P mode such as WFD or Soft-AP mode. When the item "Wireless LAN" is selected and the wireless LAN is set to be enabled by a user operation, the wireless infrastructure mode is enabled. When the item "Wireless direct" is selected and wireless direct is set to be enabled by a user operation, the P2P (WLAN) mode is enabled. This screen also displays a "Common settings" menu related to each connection mode. On this screen, the user can further set the frequency band and the frequency channel for the wireless LAN.

### Appearance of Mobile Terminal Device

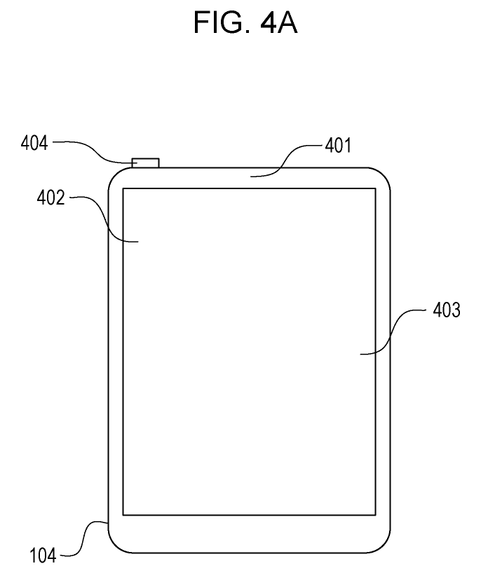

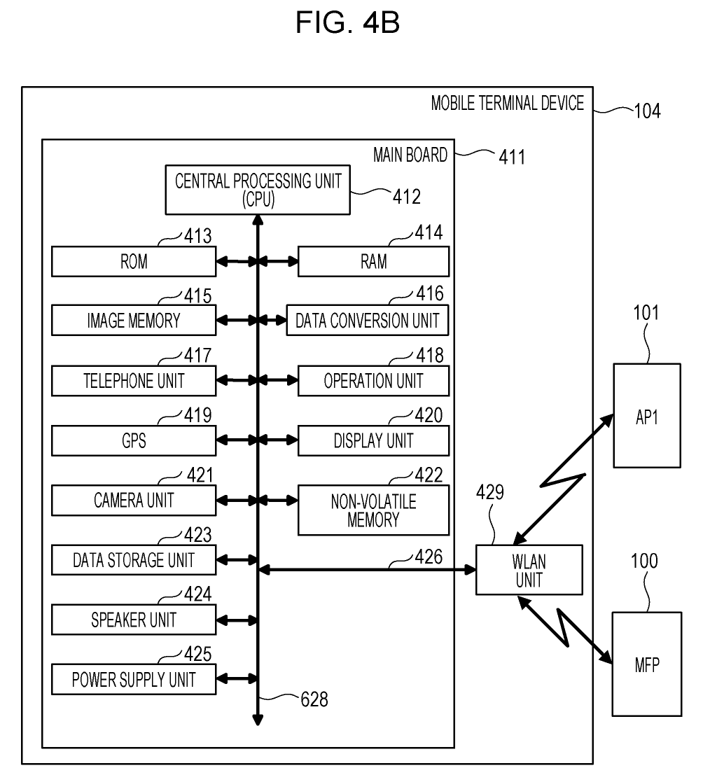

FIG. 4A is a diagram illustrating an example appearance of the mobile terminal device 104. In the present embodiment, as an example, the mobile terminal device 104 is a typical smartphone. The mobile terminal device 104 includes, for example, a display unit 402, an operation unit 403, and a power key 404. The display unit 402 is, for example, a display including an LCD display mechanism. The display unit 402 may display information by using, for example, an LED. The mobile terminal device 104 may have a function of outputting information by voice in addition to or instead of the display unit 402. The operation unit 403 includes hard keys such as keys and buttons, a touch panel, and so on to detect a user operation.

In the illustrated example, a common touch panel display is used to display information on the display unit 402 and accept a user operation by the operation unit 403. Thus, the display unit 402 and the operation unit 403 are implemented by a single device. In this case, for example, a button icon or a software keyboard is displayed using a display function of the display unit 402, and a touch by the user on the button icon or the software keyboard is detected by an operation accepting function of the operation unit 403. The display unit 402 and the operation unit 403 may be separate from each other, and hardware for display and hardware for operation acceptance may be separately provided. The power key 404 is a hard key for accepting a user operation for turning on or off the power to the mobile terminal device 104.

The mobile terminal device 104 includes a WLAN unit 401 that provides a WLAN communication function. The WLAN unit 401 may be invisible from the outside. The WLAN unit 401 is configured to execute data (packet) communication in a WLAN system conforming to, for example, the series of IEEE 802.11 standards (such as IEEE 802.11a/b/g/n/ac/ax).

In addition, the WLAN unit 401 can perform communication as a Wi-Fi Agile Multiband (trademark) AP. However, embodiments of the present disclosure are not limited to this configuration, and the WLAN unit 401 may be configured to execute communication in a WLAN system conforming to any other standard. In the illustrated example, it is assumed that the WLAN unit 401 can perform communication over both the 2.4 GHz and 5 GHz bands. It is also assumed that the WLAN unit 401 can execute communication based on WFD, communication in the Soft-AP mode, communication in the wireless infrastructure mode, and so on. Operations in these modes will be described below.

### Configuration of Mobile Terminal Device

FIG. 4B illustrates an example configuration of the mobile terminal device 104. In one example, the mobile terminal device 104 includes a main board 411 for performing main control of the mobile terminal device 104, and a WLAN unit 429 that performs WLAN communication. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. CPU is an acronym for Central Processing Unit, ROM is an acronym for Read Only Memory, RAM is an acronym for Random Access Memory, and GPS is an acronym for Global Positioning System. The mobile terminal device 104 further includes a display unit 420 and an operation unit 418. The functional units in the main board 411 described above are connected to each other via a system bus 628 managed by the CPU 412. The main board 411 and the WLAN unit 429 (the WLAN unit 401 described above) are connected to each other via, for example, a dedicated bus 426.

The CPU 412 is a system control unit including at least one processor, and controls the overall operation of the mobile terminal device 104. In one example, the processes of the mobile terminal device 104, which will be described below, are implemented by the CPU 412 executing a program stored in the ROM 413. Hardware dedicated for each of the processes may be provided. The ROM 413 stores a control program executed by the CPU 412, an embedded OS program, and so on. In the present embodiment, the CPU 412 executes each control program stored in the ROM 413 under the management of the embedded OS stored in the ROM 413 to control software such as for scheduling and for switching tasks.

The RAM 414 includes an SRAM, for example. The RAM 414 stores data such as data of program control variables, setting values registered by the user, and data for managing the mobile terminal device 104. The RAM 414 may also be used as a buffer for various works. The image memory 415 includes a memory such as a DRAM. The image memory 415 temporarily stores image data received via the WLAN unit 429 and image data read from the data storage unit 423 such that the CPU 412 processes the image data. The non-volatile memory 422 includes a memory such as a flash memory, for example, and stores data continuously even after the power to the mobile terminal device 104 is turned off. The memory configuration of the mobile terminal device 104 is not limited to the configuration described above. For example, the image memory 415 and the RAM 414 may be shared, or the data storage unit 423 may be used to back up data, for example. In the present embodiment, one example of the image memory 415 is a DRAM. However, any other storage medium such as a hard disk or a non-volatile memory may be used as the image memory 415.

The data conversion unit 416 performs analysis of data in various formats and data conversion such as color conversion and image conversion. The telephone unit 417 controls a telephone line and processes audio data input or output via the speaker unit 424 to implement telephone communication. The GPS 419 receives radio waves transmitted from satellites and acquires the position information such as the latitude and longitude of the current position of the mobile terminal device 104.

The camera unit 421 has a function of electronically recording and encoding an image input via a lens. The image data of an image captured by the camera unit 421 is stored in the data storage unit 423. The speaker unit 424 performs control to implement a function of inputting or outputting a voice for the telephone function or implement other functions such as an alarm notification. The power supply unit 425 is, for example, a portable battery and controls power supply to the mobile terminal device 104. The states of power supply include, for example, a depleted battery state in which the battery has no remaining capacity, a power-off state in which the power key 404 remains unpressed, an activated state in which the mobile terminal device 104 is normally activated, and a power-saving state in which the mobile terminal device 104 is activated and is in power saving mode.

The display unit 420 corresponds to the display unit 402 described with reference to FIG. 4A, and accepts various input operations and displays the operating state and status of the MFP 100, for example, under the control of the CPU 412. The operation unit 418 corresponds to the operation unit 403 described with reference to FIG. 4A. In response to a user operation, the operation unit 418 performs control to, for example, generate an electrical signal corresponding to the operation and output the electrical signal to the CPU 412.

In the mobile terminal device 104, the WLAN unit 429 is used to perform wireless communication and perform data communication with other devices such as the MFP 100. The WLAN unit 429 converts data into packets and transmits the packets to another device. Further, the WLAN unit 429 restores packets from another external device into original data and outputs the original data to the CPU 412. The WLAN unit 429 is a unit for implementing communication compliant with each WLAN standard. The WLAN unit 429 can operate concurrently in at least two communication modes including the wireless infrastructure mode and the P2P (WLAN) mode. The frequency bands used in these communication modes may be limited by hardware functions and capabilities.

### Configuration of Access Point

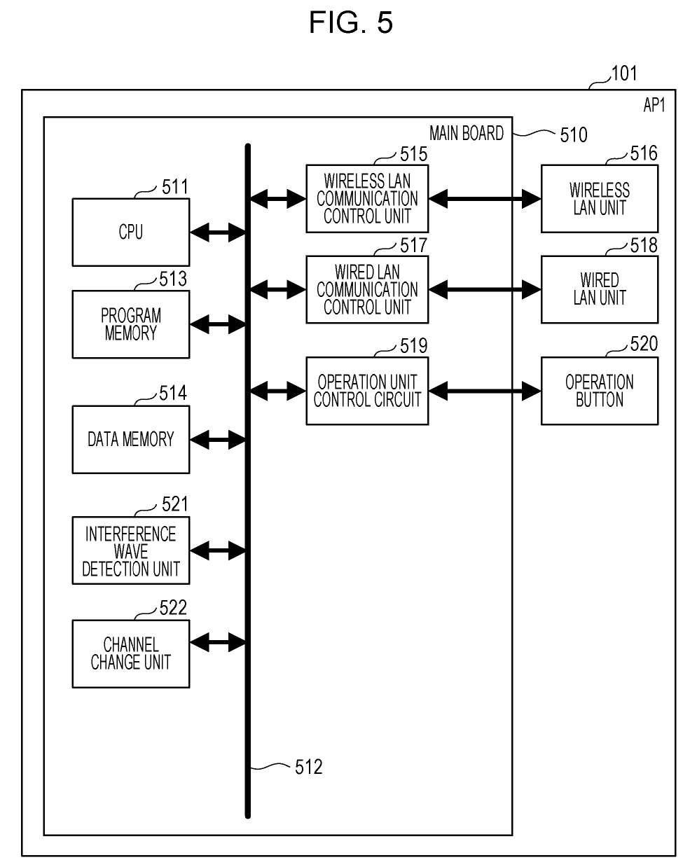

FIG. 5 is a block diagram illustrating the configuration of the access point AP1 (101) having a wireless LAN access point function. The access point AP1 (101) includes a main board 510 for controlling the access point AP1 (101), a wireless LAN unit 516, a wired LAN unit 518, and an operation button 520.

A CPU 511 is in the form of a microprocessor disposed on the main board 510 and operates in accordance with a control program stored in a program memory 513 in ROM form and the content of a data memory 514 in RAM form. The program memory 513 and the data memory 514 are connected to the CPU 511 via an internal bus 512. The CPU 511 controls the wireless LAN unit 516 through a wireless LAN communication control unit 515 to perform wireless LAN communication with other communication terminal devices. Further, the CPU 511 controls the wired LAN unit 518 through a wired LAN communication control unit 517 to perform wired LAN communication with other communication terminal devices. The CPU 511 can control an operation unit control circuit 519 to accept an operation from the user using the operation button 520. The CPU 511 includes at least one processor.

The access point AP1 (101) further includes an interference wave detection unit 521 and a channel change unit 522.

The interference wave detection unit 521 performs a process of detecting an interference wave during wireless communication performed over a band in which DFS is implemented. In response to detection of an interference wave during wireless communication performed over a band in which DFS is implemented, the channel change unit 522 performs a process of changing a channel to be used when, for example, the channel immediately needs to be changed to an available channel.

The access point AP2 (102) has a configuration similar to that of the access point AP1 (101).

### P2P Communication Method

Next, a brief description will be given of P2P (WLAN) communication method for allowing devices to wirelessly communicate directly with each other without using an external access point in WLAN communication. P2P (WLAN) communication can be implemented by using a plurality of methods. For example, a communication device supports a plurality of modes for P2P (WLAN) communication and selectively uses one of the plurality of modes to execute P2P (WLAN) communication.

The following two P2P modes are provided:
Soft-AP mode; and
WFD mode.

A communication device capable of executing P2P communication may be configured to support at least one of these modes. However, even a communication device capable of executing P2P communication need not support all of these modes, and may be configured to support only parts of these modes.

A communication device (e.g., the mobile terminal device 104) having a WFD communication function calls an application (or a dedicated application, if any) for implementing the communication function in response to a user operation accepted via an operation unit of the communication device. Then, the communication device displays a screen of a user interface (UI) provided by the application to prompt the user to perform an operation, and can execute WFD communication in response to the acceptance of the operation performed by the user.

### Soft-AP Mode

In the Soft-AP mode, a communication device (e.g., the mobile terminal device 104) operates in the role of a client that requests various services. Then, the other communication device (e.g., the MFP 100) operates as a Soft-AP that is set by software to implement the function of an AP in the WLAN. Since commands and parameters transmitted and received in a wireless connection established between the client and the Soft-AP are commands and parameters defined by the Wi-Fi (registered trademark) standard, a description thereof will be omitted. The MFP 100 operating in the Soft-AP mode operates as a master station and determines a frequency band and a frequency channel. Accordingly, the MFP 100 can select which frequency band to use from among the 5 GHz and 2.4 GHz bands and which frequency channel to use in that frequency band.

### WFD Mode

The MFP 100 may be activated as a fixed master station in the WFD mode (i.e., an autonomous group owner). In this case, a group owner (GO) negotiation process for determining the roles is not performed. In this case, furthermore, the MFP 100 operates as a master station and determines a frequency band and a frequency channel. Accordingly, the MFP 100 can select which frequency band to use from among the 5 GHz and 2.4 GHz bands and which frequency channel to use in that frequency band.

### Wireless Infrastructure Mode

In the wireless infrastructure mode, communication devices (e.g., the mobile terminal device 104 and the MFP 100) that communicate with each other are connected to an external AP (e.g., the access point AP1 (101)) that controls the network, and the communication between the communication devices is performed via the external AP. In other words, communication is performed between the communication devices via a network established by the external AP. The mobile terminal device 104 and the MFP 100 individually discover the access point AP1 (101), transmit a connection request to the access point AP1 (101), and connect to the access point AP1 (101). As a result, these communication devices can communicate with each other in the wireless infrastructure mode via the access point AP1 (101). A plurality of communication devices may connect to different APs. In this case, data transfer is performed between the APs to allow communication between the communication devices. Since commands and parameters transmitted and received during communication between the communication devices via an access point or access points are commands and parameters defined by the Wi-Fi (registered trademark) standard, a description thereof will be omitted. In this case, the access point AP1 (101) determines a frequency band and a frequency channel. Accordingly, the access point AP1 (101) can select which frequency band to use from among the 5 GHz, 2.4 GHz, and 6 GHz bands and which frequency channel to use in that frequency band.

### Process in Response to Connection Destination Change Request from AP to STA

The mobile terminal device 104 and the MFP 100 support a feature publicly available as Wi-Fi Agile Multiband (trademark). The Wi-Fi Agile Multiband feature enables selection of an optimal environment in accordance with the changing situation of a Wi-Fi network. Specifically, a STA, such as the mobile terminal device 104 and the MFP 100, and an AP, such as the access point AP1 (101), exchange information on the network environment by using the series of IEEE 802.11 communication standards. The exchange of such information allows the AP to guide the STA to another AP, frequency band, or channel, or even to another cellular service in some cases (change the connection destination) when the network is congested.

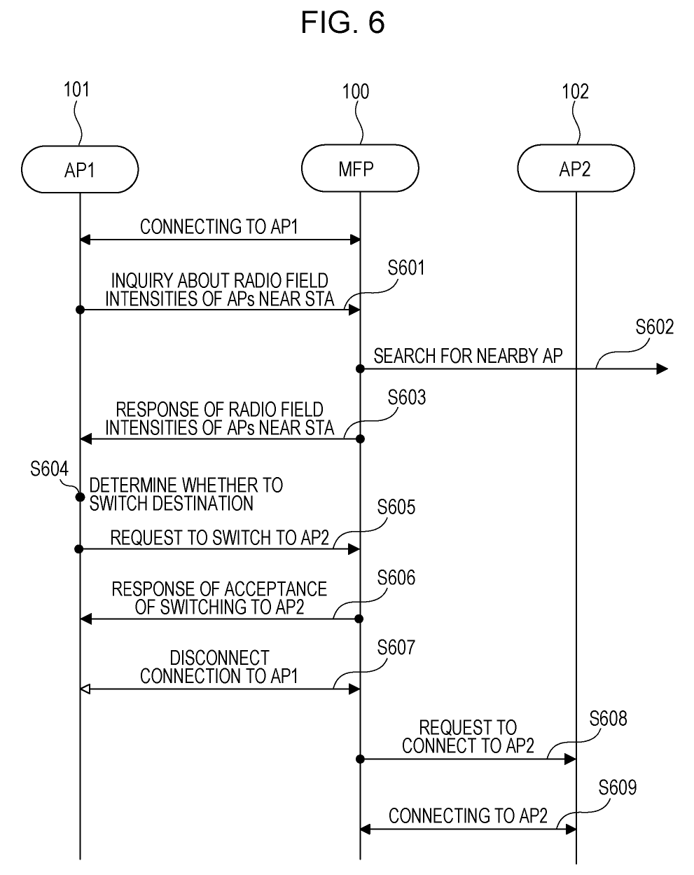

FIG. 6 is a sequence diagram of a process in which the MFP 100 switches a connection destination AP to connect to from the access point AP1 (101) to the access point AP2 (102) in accordance with a connection destination change request from the access point AP1 (101).

The processing executed by each device in the illustrated sequence is implemented by a CPU included in the device reading various programs stored in a memory such as a ROM included in the device into a RAM included in the device and executing the programs.

In the process illustrated in FIG. 6, in the initial state, the MFP 100 has established a connection with the access point AP1 (101) in the wireless infrastructure mode. When the MFP 100 and the access point AP1 (101) are connected to each other in the wireless infrastructure mode, the access point AP1 (101) has acquired information indicating whether the MFP 100 supports IEEE 802.11v. The following process is performed if information indicating that the MFP 100 supports IEEE 802.11v has been acquired by the access point AP1 (101).

In S601, the access point AP1 (101) transmits, to the MFP 100, an inquiry (measurement requests) about the radio field intensities of APs located near the MFP 100. The inquiry is transmitted as, for example, a beacon frame request or a beacon report request. That is, a request defined by the IEEE 802.11k standard can be used.

In S602, in response to the request received in S601, the MFP 100 receives frames transmitted from the APs located near the MFP 100 and measures the respective radio field intensities of the APs. As a result, the radio field intensity of each of a plurality of APs including the access points AP1 (101) and AP2 (102) is measured.

In S603, the MFP 100 transmits a list of radio field intensities of the APs located near the MFP 100, which are measured in S602, as a response to the request received in S601. The radio field intensities to be transmitted as the response may be, in addition to or instead of the information measured in S602, information stored in, for example, the RAM 214 and the non-volatile memory 215 of the MFP 100. The response is transmitted as, for example, Beacon Report or measurement reports.

In S604, the access point AP1 (101) determines whether to switch the connection destination of the MFP 100, on the basis of the network congestion recognized by the access point AP1 (101) and the radio field intensities received from the MFP 100 in S603. Examples of the factors for the access point AP1 (101) to determine to change the connection destination include a large number of STAs connected, a large amount of communication, reduced congestion in a network for another AP, the presence or absence of interfering radio waves, and a stoppage of the AP function. If the access point AP1 (101) determines to switch the connection destination of the MFP 100 and determines the service set identifier (SSID) of another AP to be designated as a destination to which the MFP 100 is to be connected, a channel, and a frequency band, the process proceeds to S605.

In S605, the access point AP1 (101) transmits an AP change request (connection destination change request) to the MFP 100. The connection destination change request includes information on the SSID of the other AP designated as the destination to which the MFP 100 is to be connected, the channel, and the frequency band, which are determined in S604.

A plurality of SSIDs may be designated. The connection destination change request is transmitted as, for example, a basic service set (BSS) transition management (BTM) Request. That is, a BTM Request frame defined by the IEEE 802.11v standard is transmitted. In the example illustrated in FIG. 6, the access point AP2 (102) is designated as the destination included in the connection destination change request.

In S606, if the MFP 100 follows the connection destination change request received in S605, the MFP 100 transmits to the access point AP1 (101) a response indicating acceptance of the switching of the connection destination. If the MFP 100 does not follow the connection destination change request, the MFP 100 may transmit a response indicating rejection of the switching of the connection destination. The response is transmitted as a BTM Response. In the example illustrated in FIG. 6, it is assumed that a response indicating acceptance of the switching of the connection destination is transmitted.

In S607, the access point AP1 (101) and the MFP 100 disconnect the connection in the wireless infrastructure mode.

In S608, the MFP 100 transmits a connection request to the access point AP2 (102) so as to connect to the access point AP2 (102) designated by the connection destination change request received in S605.

As a result, in S609, a connection between the MFP 100 and the access point AP2 (102) in the wireless infrastructure mode is established.

This mechanism allows the MFP 100 serving as an STA to change the connection destination from the access point AP1 (101) to the access point AP2 (102) in accordance with a connection destination change request from the access point AP1 (101) to which the MFP 100 is originally connected. The access points AP1 (101) and AP2 (102) may be located in different locations. That is, through the process illustrated in FIG. 6, the MFP 100 can switch the connection destination from an AP to which the MFP 100 is originally connected to another AP installed at a different position. The access points AP1 (101) and AP2 (102) may support different frequency bands among a plurality of frequency bands (two or three of the 2.4 GHz, 5 GHz, and 6 GHz bands) provided by the same device. That is, through the process illustrated in FIG. 6, the MFP 100 can switch the frequency band to another frequency band provided by the same device as the AP to which the MFP 100 is originally connected. For example, the MFP 100 can change the connection destination to an AP in the 6 GHz band in response to a connection destination change request.

The present embodiment describes an example in which a measurement request and a connection destination change request are transmitted from an AP by using a mechanism compliant with Wi-Fi Agile Multiband (trademark) and an STA responds to these requests. However, the present disclosure is not limited to this example. The present embodiment is also applicable when an STA responds and changes a connection destination AP (switching, deletion, or addition of an AP serving as a connection destination) in response to a measurement request and a connection destination change request transmitted from an AP by using a mechanism different from that in the example described above.

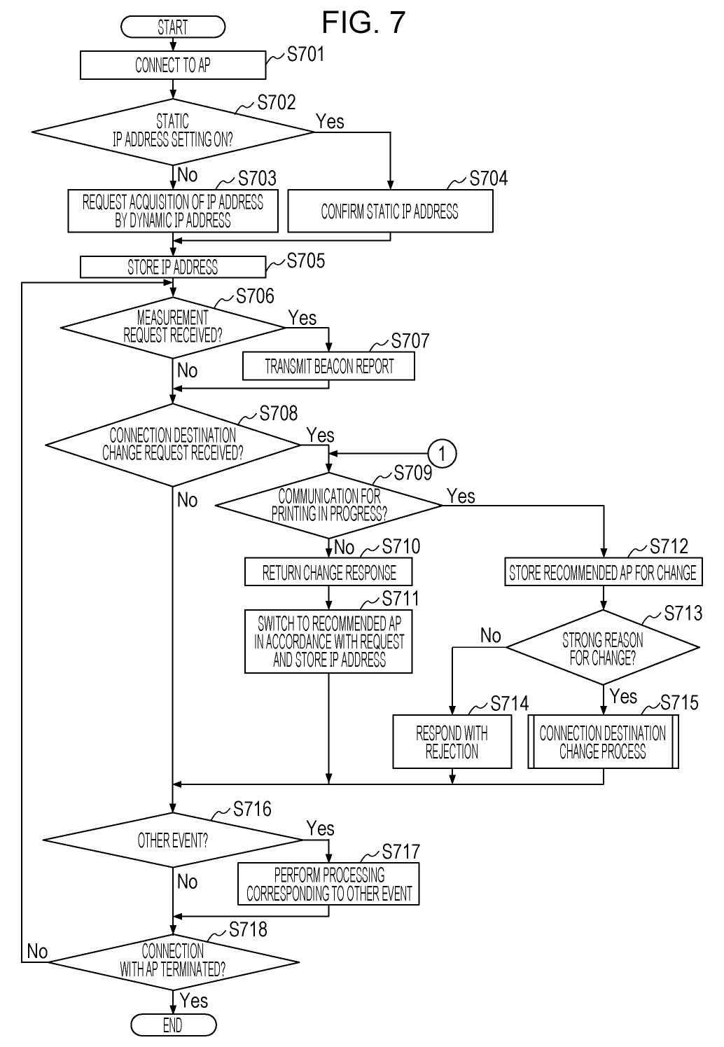

FIG. 7 is a flowchart of a process performed by the MFP 100 in response to a connection destination change request. The illustrated process is implemented by the CPU 212 loading a program stored in the ROM 213 into the RAM 214 and executing the program. When the power to the MFP 100 is turned on or the wireless communication function is turned on, the process illustrated in FIG. 7 is started.

In S701, the CPU 212 starts connecting to a preset AP (registered AP). The SSID and the password of the preset AP are recorded in the non-volatile memory 215, and the CPU 212 uses the recorded information to connect to the registered AP. In the present embodiment, it is assumed that the access point AP1 (101) has been registered as the registered AP. In some cases, the connection to the registered AP fails for reasons such as failure to receive radio waves from the registered AP. However, a description of such cases will be omitted. When a wireless connection (Wi-Fi connection) is established with the registered AP, the process proceeds to S702.

In S702, the CPU 212 determines whether the IP address setting of the MFP 100 is a static IP address setting. If a dynamic IP address setting is off and it is determined that the static IP address setting is enabled, the process proceeds to S704. If it is determined that the static IP address setting is not enabled, the process proceeds to S703. When the dynamic IP address setting by DHCP is on (DHCP is set to be enabled), it is determined that the static IP address setting is off, and the process proceeds to S703. That is, the processing of S702 is also a determination as to whether the DHCP setting is enabled in the MFP 100. The dynamic IP address setting is configured as, for example, a setting item name such as "automatic obtaining", and a state in which automatic obtaining is enabled is a state in which the dynamic IP address setting is on. When the dynamic IP address setting is disabled (or off, that is, DHCP is set to be disabled) and the IP address used as the static IP address is set, it is determined that the static IP address setting is on, and the process proceeds to S704. In the present embodiment, the protocol used for dynamic IP addresses is DHCP, by way of example but not limitation.

As used herein, the term "dynamic IP address" refers to an IP address assigned by the DHCP server 103. When the DHCP setting is on, the MFP 100 acquires an IP address by using DHCP. The term "static IP address" refers to an IP address manually set by the user of the MFP 100. The MFP 100 confirms that the static IP address is manually set, and determines whether the static IP address setting is on.

In S703, the CPU 212 performs control to request the DHCP server 103 to assign a dynamic IP address. That is, the CPU 212 issues a DHCP Discover command and requests assignment of an IP address. The DHCP server 103 transmits DHCP Offer as a response to notify the MFP 100 that an available IP address can be assigned. The MFP 100 issues a DHCP Request command to the DHCP server 103 with designation of an IP address notified as being available for assignment according to the DHCP Offer, and requests the DHCP server 103 to assign the IP address. If the IP address designated by the MFP 100 can be assigned, the DHCP server 103 transmits DHCP ACK as a response to confirm the IP address (dynamic IP address) of the MFP 100.

In S704, the CPU 212 confirms the IP address by the static IP address. That is, the IP address set by the user and stored in the ROM 213 is confirmed as the IP address of the MFP 100.

In S705, the CPU 212 stores the dynamic IP address assigned by the DHCP server 103 or the static IP address in the RAM 214.

Accordingly, the connection is established with the access point AP1 (101) in the wireless infrastructure mode. When the MFP 100 and the access point AP1 (101) are connected to each other in the wireless infrastructure mode, the access point AP1 (101) acquires information indicating whether the MFP 100 supports IEEE 802.11v. In the present embodiment, a description will be given on the assumption that the MFP 100 supports IEEE 802.11v.

In S706, the CPU 212 determines whether a measurement request (the measurement requests described above in S601 in FIG. 6) is received from the access point AP1 (101). If a measurement request is received, the process proceed to S707; otherwise, the process proceed to S708.

In S707, as described in S602 and S603 in FIG. 6, the CPU 212 uses the wireless unit 226 to measure the radio field intensities of APs located near the MFP 100, and transmits a list of the radio field intensities of the APs to the access point AP1 (101) as Beacon Report.

In S708, the CPU 212 determines whether a connection destination change request (described above in S605) is received from the access point AP1 (101). If a connection destination change request is received, the process proceed to S709; otherwise, the process proceed to S716.

In S709, the CPU 212 determines whether the MFP 100 is performing application-layer communication, that is, communication for executing a printing process, with the mobile terminal device 104 to which the MFP 100 is connected via the currently connected access point AP1 (101). If the MFP 100 is performing communication for executing printing, the process proceeds to S712; otherwise, the process proceeds to S710. The communication for executing the printing process is in progress in a state where part of print data of an image to be printed has been received from the mobile terminal device 104, which is the partner device, and the reception of the rest of the print data has not been completed. In the MFP 100, not all of the print data to be printed on one sheet of paper is stored. Upon reception of part of the print data, the MFP 100 prints the received part of the print data (e.g., receives data of a line and prints the line). Upon reception of a subsequent part of the print data, the MFP 100 prints the subsequent part of the print data. The operations described above are repeated to perform printing. Even during printing, No is determined in S709 during printing for maintenance purposes that do not involve communication with the partner device because of the use of the print data stored in the MFP 100. The printing for maintenance purposes includes, for example, the following types of printing:
automatic registration adjustment printing for printing and reading an adjustment pattern to adjust vertical line distortion and color shift and performing head position adjustment;
nozzle check pattern printing for checking clogging of a nozzle;
printing of an adjustment pattern (printing for color calibration) to set a calibration adjustment value for correcting a variation in tint due to an individual difference characteristic of the MFP 100 or a change over time; and
printing of an adjustment pattern (printing for band adjustment) to finely adjust the paper feed amount.

In S710, the CPU 212 transmits, to the access point AP1 (101), a response indicating that the connection destination is to be changed in accordance with the received connection destination change request (the request is accepted). This processing corresponds to the processing of S606 in FIG. 6.

In S711, the CPU 212 disconnects the connection to the access point AP1 (101), and executes a process of connecting to an AP recommended for connection included in the connection destination change request. That is, the CPU 212 changes the connection destination AP in accordance with the connection destination change request. More specifically, the CPU 212 performs the processing described in S606 to S609 in FIG. 6. When the dynamic IP address setting is on (if No is determined in S702), the CPU 212 further performs processing similar to the processing of S703 to newly acquire a dynamic IP address, and stores the dynamic IP address in the RAM 214 as the IP address of the MFP 100. That is, in a situation where No is determined in S709, a dynamic IP address is newly acquired in accordance with the change of the connection destination based on the connection destination change request, and the IP address is allowed to be changed.

In S712, the CPU 212 stores information on the recommended AP for change included in the received connection destination change request (information for identifying the recommended AP for change including the BSSID) in the RAM 214 of the MFP 100.

In S713, the CPU 212 refers to the reason for the change, which is included in the received connection destination change request, and determines whether the reason for the change is strong. If the reason is strong, the process proceeds to S715; otherwise, the process proceeds to S714. For example, when the Disassociation Imminent bit or the BSS Termination Included bit in the Request Mode field of the BTM Request is set to 1, it is determined that the request is strong.

In S714, the CPU 212 transmits, to the access point AP1 (101), a response indicating that the change of the connection destination based on the connection destination change request is rejected. This processing corresponds to transmission of a rejection response in S606 in FIG. 6. In S714, since the reason for the change is not strong, even if a change rejection response is transmitted, the communication with the MFP 100 may be less likely to be forcibly disconnected from the access point AP1 (101) upon receipt of the response. That is, the access point AP1 (101) can be expected to raise the priority of maintaining the connection with the MFP 100 by, for example, transmitting a connection destination change request to another STA different from the MFP 100 connected to the access point AP1 (101). As described above, if there is no strong reason for the change, the CPU 212 transmits a change rejection response in expectation that the connection with the access point AP1 (101) can be maintained.

Alternatively, the MFP 100 may not respond to (i.e., ignore) the connection destination change request without transmitting a rejection response to the access point AP1 (101). In S714, in any case, the CPU 212 performs control not to change the connection destination in accordance with the connection destination change request.

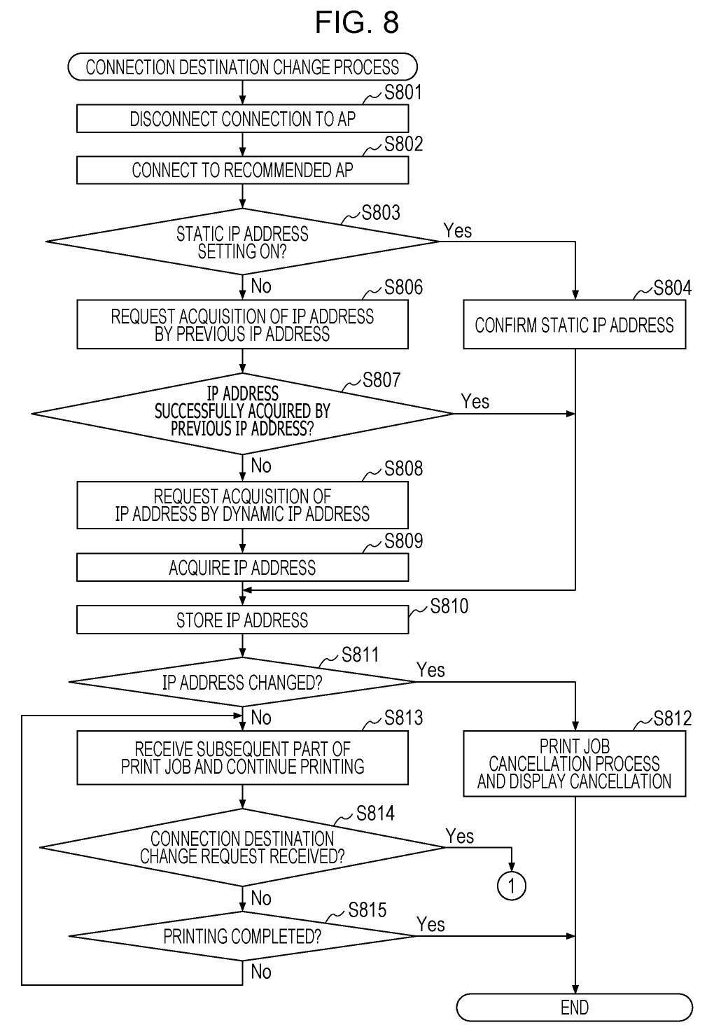

In S715, the CPU 212 performs a connection destination change process to change the connection destination in accordance with the connection destination change request. The connection destination change process will be described below with reference to FIG. 8.

In the present embodiment, the determination of S713 is performed, and the connection destination is changed in accordance with the connection destination change request only when the connection destination change request for which the reason for the change is strong is received during a process (printing process) involving communication, by way of example but not limitation. After S712, the process may skip S713 and proceed to S715, regardless of whether the reason for the change is strong, to change the connection destination in accordance with the connection destination change request.

In S716, the CPU 212 determines whether any other event has occurred. If any other event has occurred, the process proceeds to S717; otherwise, the process proceeds to S718.

In S717, the CPU 212 performs processing corresponding to the event that has occurred. For example, the CPU 212 performs processing involving copying or cloud communication in response to a key operation or a touch panel operation from the operation display unit 205. If an event has occurred such as a user operation for enabling the dynamic IP address setting described above or a user operation for manually inputting a static IP address, the content of the setting corresponding to the operation is recorded in the ROM 213. In another example, if an operation event has occurred for registering an AP to be registered (registering the SSID and the password of an AP to be registered), a registration process is performed in accordance with the operation.

If an operation event that gives an instruction to perform copying has occurred in S716, then in S717, the CPU 212 drives the reading unit 219 to read a document and causes the printing unit 222 to print an image of the read document to perform copying. This processing (new printing process) is executable unless the processing of S812 in FIG. 8 (described below) is performed. The processing of S812 is a process of canceling the printing process of a print job that cannot be printed to the end as a result that the rest of the print data being printed is made unreceivable due to the change of the IP address.

In S718, the CPU 212 determines whether the wireless connection with the currently connected AP has been terminated (disconnected). The termination of the wireless connection, which is determined here, occurs in response to, for example, an event of turning off the power to the MFP 100, a setting of disabling the wireless connection, or failure to receive a radio wave from the currently connected AP. In S718, disconnection from the original connection destination due to the processing of changing the connection destination in accordance with the connection destination change request is not to be determined. If the wireless connection with the currently connected AP has not been terminated, the process returns to S706. If the wireless connection with the currently connected AP has been terminated, the process illustrated in FIG. 7 ends.

FIG. 8 is a flowchart of the connection destination change process in S715 in FIG. 7 described above. The illustrated process is implemented by the CPU 212 loading a program stored in the ROM 213 into the RAM 214 and executing the program.

In S801, the CPU 212 transmits a response indicating acceptance of the change based on the connection destination change request to the AP being connected before the change of the connection destination (e.g., the access point AP1 (101)), and then disconnects the wireless connection with the currently connected AP (i.e., the access point AP1 (101)).

In S802, the CPU 212 wirelessly connects to the recommended AP for change (e.g., the access point AP2 (102)) by using information on the recommended AP for change. The information on the recommended AP for change is included in the connection destination change request received from the AP being connected before the change of the connection destination (i.e., the access point AP1 (101)) and is recorded in S712.

In S803, the CPU 212 determines whether the IP address setting of the MFP 100 is a static IP address setting. This determination is similar to the determination of S702 in FIG. 7. If the static IP address setting is enabled, the process proceeds to S804. If the static IP address setting is not enabled (i.e., the dynamic IP address setting is enabled), the process proceeds to S806.

In S804, the CPU 212 confirms the IP address by the static IP address. Then, the process proceeds to S810. This processing is similar to the processing of S704 in FIG. 7.

In S806, the CPU 212 issues a DHCP Request command to the DHCP server 103, from which the dynamic IP address is obtained, with designation of the previously used IP address, and requests the DHCP server 103 to assign the IP address. The previously used IP address is the IP address stored in S705 through the processing of S703, and is the IP address used at the time of connection to the access point AP1 (101) to which the MFP 100 has been connected before the change of the connection destination.

In S807, the CPU 212 determines whether the same IP address as the previously used IP address is successfully acquired from the DHCP server 103. If the previously used IP address is successfully acquired, the process proceeds to S810; otherwise, the process proceeds to S808.

In S808, the CPU 212 requests the DHCP server 103 to assign a dynamic IP address. This processing is similar to the processing of S703 in FIG. 7.

In S809, the CPU 212 receives the DHCP ACK transmitted from the DHCP server 103 to the MFP 100 as a response, and acquires the IP address of the MFP 100 from the information included in the DHCP ACK.

In S810, the CPU 212 stores, in the RAM 214, any one of the static IP address confirmed in S804, the previous IP address successfully acquired from the DHCP server 103, and the dynamic IP address newly assigned by the DHCP server 103 in S809.

In S811, the CPU 212 determines whether the IP address confirmed at the time of connection to the AP (i.e., the access point AP2 (102)) after the change of the connection destination, namely, the IP address stored in S810, has changed from the previous IP address used at the time of connection to the AP (i.e., the access point AP1 (101)) before the change of the connection destination. If the IP address has changed (i.e., if the IP address stored in S810 is different from the previous IP address), the process proceeds to S812. If the IP address has not changed (i.e., if the IP address stored in S810 and the previous IP address are the same), the process proceeds to S813.

In S812, the CPU 212 performs a process of canceling the standby mode waiting for communication with the mobile terminal device 104 and canceling (interrupting) the printing process that has been executed through communication with the mobile terminal device 104. In S812, since the IP address has changed due to the change of the connection destination, it is difficult to continue the application-layer communication with the mobile terminal device 104 with which the MFP 100 has communicated before the change of the connection destination. That is, it is difficult for the mobile terminal device 104 to find the MFP 100 by the IP address used so far.

Thus, communication cannot take place, making it difficult to continue the printing process executed through the communication. Accordingly, the CPU 212 performs a process of canceling the communication with the mobile terminal device 104 and canceling the printing process that has been executed through communication with the mobile terminal device 104. This processing includes a process of ejecting a sheet that is being printed. At this time, the display of the operation display unit 220 of the MFP 100 may display a screen indicating that the process associated with the communication has been canceled.

In S813, the CPU 212 continues the communication with the partner device, namely, the mobile terminal device 104, and continuously executes the printing process. In this case, the connection destination AP has been changed in accordance with the connection destination change request, but the IP address has not changed. Thus, the CPU 212 can continue the application-layer communication with the mobile terminal device 104. That is, it is possible for the mobile terminal device 104 to communicate with the MFP 100 by designating the IP address used so far. As a result, the printing process involving communication is continuously executed, and the print data included in the print job can be printed to the end.

In S814, the CPU 212 determines whether a connection destination change request transmitted from the currently connected AP (in this case, the access point AP2 (102)) is received. That is, it is determined whether a request to further change the connection destination has been made from the access point AP2 (102). If a connection destination change request is received, the process proceed to S709 in FIG. 7; otherwise, the process proceed to S815.

In S815, the CPU 212 determines whether the printing process involving the communication with the mobile terminal device 104, which is continued in S813, is completed (e.g., whether the print job has been printed to the end). If it is determined that printing is completed, the process illustrated in FIG. 8 ends, and then the process proceeds to S716 in FIG. 7; otherwise, the process returns to S813.

In response to detection of a duplication of an IP address due to the use of a static IP address of the MFP 100 in S804 in FIG. 8 after the connection destination is changed to the access point AP2 (102), any of the processes below may be performed. A duplication of an IP address is detected when, for example, devices having the same IP address and different media access control (MAC) addresses are present in the Address Resolution Protocol (ARP) table.

One process is to reconnect to the AP before switching (before the connection destination change) (i.e., the process proceed to S701).

Another process is to display a message indicating a duplication of an IP address on the display of the operation display unit 220 and disconnect the network.

Another process is to dynamically acquire an IP address from the DHCP server 103 (i.e., the process proceeds to S808).

The present embodiment has described the acquisition of an Internet Protocol version 4 (IPv4) address by DHCP. Features of the present disclosure can also be applied to the acquisition of an Internet Protocol version 6 (IPv6) address. In the acquisition of an IPv6 address, the MFP 100 transmits a DHCPv6 Request message to the DHCP server 103 to request the same IPv6 address. If the request fails, the MFP 100 transmits a DHCPv6 Solicit message and reacquires the IPv6 address.

The processing of S806 described above makes a request to the DHCP server 103 for the IP address used before switching of the connection destination AP, thereby making it possible to avoid the change of the IP address due to the change of the connection destination. Accordingly, it is possible to continue a process (e.g., a printing process) involving communication with the mobile terminal device 104 with which the MFP 100 has communicated by using the IP address before the change of the connection destination. That is, even if the connection destination is switched based on the connection destination change request during the process, the process can be continuously performed.

In the present embodiment, in response to reception of a connection destination change request in a situation where it is determined in S709 that a specific process involving communication is in progress, in S806, control is performed such that the IP address remains unchanged before and after the connection destination is changed, by way of example but not limitation. When the connection destination AP is changed based on the connection destination change request, control may be performed such that, as in S806, the IP address remains unchanged before and after the connection destination is changed, regardless of whether a specific process involving communication is in progress.

In addition, the processing of S806 described above makes a request to the DHCP server 103 for the IP address used before switching of the connection destination AP, thereby avoiding the change of the IP address due to the change of the connection destination, by way of example but not limitation. In S806, the static IP address setting may be automatically turned on (i.e., the dynamic IP address setting is turned off), and the previous IP address, which is acquired as a dynamic IP address before the change of the connection destination, may be used as the static IP address to confirm the IP address. This makes it possible to more reliably prevent the IP address from changing before and after the change of the connection destination based on the connection destination change request.

Further, through the processing of S812 described above, the specific process (e.g., a printing process) that is in progress and involves communication is canceled if the IP address of the MFP 100 has changed due to the change of the connection destination AP based on the connection destination change request. The cancellation of the process that is in progress and involves communication makes it possible to accept another subsequent process, which is otherwise unacceptable due to a long wait for reception of the unreceived remaining data for the process. That is, it is possible to avoid a wait for reception of the remaining data to rapidly start accepting the next process. Accordingly, the next process can be started immediately upon being accepted.

While the processing performed during reception of print data has been described above, similar processing can be applied during reception of other data different from print data or during transmission of the other data. For example, similar processing can be applied when the reading unit 219 scans a document and transmits an image (image data) of the scanned document to the mobile terminal device 104 via an AP. In this case, if Yes is determined in S708 in FIG. 7 described above, instead of or in addition to the determination of S709, it is determined whether a scan-and-send process is in progress. If the scan-and-send process is not in progress, the process proceeds to S710. If the scan-and-send process is in progress, the processing of S712 to S715 and the process illustrated in FIG. 8, in which the "printing" described above is replaced with "scan-and-send", are executed.

In the present embodiment, although control is performed in S806 such that the IP address does not change before and after the change of the connection destination, the IP address may change. In this case, the specific process (e.g., a printing process) that is in progress and involves communication is canceled in S812, by way of example but not limitation. The control for keeping the IP address unchanged before and after the change of the connection destination (i.e., the control in S806) may be omitted. That is, when the connection destination AP is changed based on the connection destination change request, a dynamic IP address may be newly acquired, and the change of the IP address may be allowed, regardless of whether a specific process involving communication is in progress. In this case, the IP address is likely to change before and after the change of the connection destination. Accordingly, the determination as to whether the IP address has changed before and after the change of the connection destination (i.e., the determination of S811) may be omitted, and the specific process that is in progress and involves communication may always be canceled, as in S812, in response to the connection destination being changed based on the connection destination change request.

The various types of control described above as being performed by the CPU 212 may be performed by one piece of hardware, or a plurality of pieces of hardware (e.g., a plurality of processors or circuits) may share processing to control the overall operation of the MFP 100.

While exemplary embodiments have been described, the present invention is not limited to these specific embodiments and may be modified in various ways without departing from the scope of the disclosure. Such modifications also fall within the scope of the present disclosure. The embodiments described above are examples of the present invention, and any combination thereof may be used.

In the embodiments described above, furthermore, features of the present disclosure are applied to an MFP, by way of example. However, the present invention is not limited to the illustrated example, and is applicable to any wireless device that functions as an STA capable of performing a process in accordance with a connection destination change request from an AP. That is, the present invention is applicable to a PC, a PDA, a tablet terminal, a mobile phone terminal such as a smartphone, a music player, a game device, an electronic book reader, a smart watch, and various measurement devices (sensor devices) such as a thermometer and a hygrometer, for example. The present invention is also applicable to digital cameras (including a still camera, a video camera, a network camera, and a security camera), a printer, a scanner, and a drone, for example. Embodiments of the present disclosure are also applicable to a video output device, an audio output device (e.g., a smart speaker), a media streaming player, and a wireless LAN slave device (adapter) connectable to a Universal Serial Bus (USB) terminal or a LAN cable terminal. The video output device includes, for example, a device such as a set-top box and is configured to acquire (download) a moving image or a still image from the Internet, which is identified by a uniform resource locator (URL) specified by an electronic apparatus, and output the moving image or the still image to a display device connected via a video output terminal such as a High-Definition Multimedia Interface (HDMI (registered trademark)) video output terminal. This configuration implements streaming playback on the display device and implements mirroring display (display that allows content displayed on the electronic apparatus to also be displayed on the display device). In addition, the video output device includes media players such as a hard disk recorder, a Blu-ray recorder, and a DVD recorder, a head mounted display, a projector, a television, a display device (monitor), and a signage device, for example. Embodiments of the present disclosure are also applicable to Wi-Fi-enabled devices called smart home appliances, such as a smart air conditioner, a smart refrigerator, a smart washing machine, a smart vacuum cleaner, a smart oven, a smart microwave oven, a smart lighting system, a smart heater, and a smart cooler.

According to an embodiment of the present disclosure, it is possible to prevent failure to perform another process immediately upon a change of an AP serving as a connection destination according to a request for changing the connection destination during a specific process involving communication.

According to an embodiment of the present disclosure, furthermore, it is possible to prevent failure in transmission or reception of data when an AP serving as a connection destination is switched in response to a request for changing the connection destination.

That is, it is possible to improve convenience for a change of an AP serving as a connection destination according to a request for changing the connection destination during a specific process involving communication.

### Other Embodiments

Various embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

What is claimed is:

1. An electronic apparatus comprising at least one memory and at least one processor which function as:
an acquisition unit configured to acquire a dynamic Internet Protocol (IP) address as an IP address of the electronic apparatus;
a receiving unit configured to receive a change request from a currently connected access point (AP) to change a connection destination AP to connect to;
a processing unit configured to communicate with another apparatus via the currently connected AP and perform a specific process including transmission or reception of data; and
a control unit configured to perform a connection destination change based on the change request to change the connection destination AP, and perform control such that an IP address of the electronic apparatus after the connection destination change is performed is identical to a first IP address, the first IP address being acquired by the acquisition unit before the connection destination change is performed.

2. The electronic apparatus according to claim 1, wherein
the control unit performs, when performing the connection destination change based on the change request in a first state in which part of data for the specific process has been received or transmitted through communication with the other apparatus and reception or transmission of rest of the data has not been completed, control such that the IP address of the electronic apparatus after the connection destination change is performed is identical to the first IP address.

3. The electronic apparatus according to claim 2, wherein
the control unit performs, in a second state in which no transmission or reception of the data for the specific process is performed, control of the acquisition unit to newly acquire a dynamic IP address when the connection destination change based on the change request is performed.

4. The electronic apparatus according to claim 3, wherein
the control unit is configured to, in the second state, allow the IP address of the electronic apparatus to be changed before and after the connection destination change based on the change request is performed.

5. The electronic apparatus according to claim 1, wherein
the acquisition unit acquires the dynamic IP address from a dynamic host configuration protocol (DHCP) server, and
the control unit performs control to make a request to the DHCP server for the first IP address when the connection destination change based on the change request is performed, to perform control such that the IP address of the electronic apparatus after the connection destination change is performed is identical to the first IP address.

6. The electronic apparatus according to claim 5, wherein
the control unit performs, in a case where the acquisition unit fails to acquire the first IP address for which the request is made to the DHCP server when the connection destination change based on the change request is performed, control of the acquisition unit to newly acquire a dynamic IP address.

7. The electronic apparatus according to claim 5, wherein
the control unit performs, in a case where the acquisition unit fails to acquire the first IP address for which the request is made to the DHCP server when the connection destination change based on the change request is performed, control to reconnect to an AP connected before the connection destination change is performed.

8. The electronic apparatus according to claim 1, wherein
the acquisition unit acquires a dynamic host configuration protocol version 6 (DHCPv6) IP address.

9. The electronic apparatus according to claim 1, wherein
in a case where the control unit fails to perform the control such that the IP address of the electronic apparatus after the connection destination change is performed is identical to the first IP address, the control unit performs control to cancel the specific process that is in progress when the change request is received.

10. The electronic apparatus according to claim 1, wherein
the electronic apparatus performs IEEE 802.11ax connection to an AP and performs a process compliant with an IEEE 802.11ax standard.

11. The electronic apparatus according to claim 1, wherein
the electronic apparatus performs at least one of a process compliant with Orthogonal Frequency Division Multiple Access (OFDMA) and a process compliant with Target Wake Time (TWT).

12. The electronic apparatus according to claim 1, wherein
the connection destination change based on the change request is performed to change the connection destination AP to an AP using a 6 GHz frequency band.

13. A method for controlling an electronic apparatus, the method comprising:
an acquisition step of acquiring a dynamic Internet Protocol (IP) address as an IP address of the electronic apparatus;
a receiving step of receiving a change request from a currently connected access point (AP) to change a connection destination AP to connect to;
a processing step of communicating with another apparatus via the currently connected AP and performing a specific process including transmission or reception of data; and
a control step of performing a connection destination change based on the change request to change the connection destination AP and performing control such that an IP address of the electronic apparatus after the connection destination change is performed is identical to a first IP address, the first IP address being acquired in the acquisition step before the connection destination change is performed.

14. A non-transitory computer-readable storage medium storing one or more programs configured to cause one or more computers to function as:
an acquisition unit configured to acquire a dynamic Internet Protocol (IP) address as an IP address of the electronic apparatus;
a receiving unit configured to receive a change request from a currently connected access point (AP) to change a connection destination AP to connect to;
a processing unit configured to communicate with another apparatus via the currently connected AP and perform a specific process including transmission or reception of data; and
a control unit configured to perform a connection destination change based on the change request to change the connection destination AP, and perform control such that an IP address of the electronic apparatus after the connection destination change is performed is identical to a first IP address, the first IP address being acquired by the acquisition unit before the connection destination change is performed.
